(19) United States
(12) Patent Application Publication
(10) Pub. No.: US 2013/0099631 A1
(43) Pub. Date: Apr. 25, 2013

(54) Vertical hobby servo mounts

(71) Applicant: Brian T. Pettey, Winfield, KS (US)

(72) Inventor: Brian T. Pettey, Winfield, KS (US)

(73) Assignee: ROBOTZONE, LLC, Winfield, KS (US)

(21) Appl. No.: 13/616,316

(22) Filed: Sep. 14, 2012

Related U.S. Application Data
(60) Provisional application No. 61/550,629, filed on Oct. 24, 2011.

(51) Int. Cl. H02K 5/22; H02K 11/00

(52) U.S. Cl. 310/68 B; 310/91

(57) ABSTRACT

Hobby servo mounts are provided. In certain circumstances, a servo mount includes a top panel, a bottom panel, and a side panel. The top panel is configured to secure a hobby servo motor to the hobby servo mount. The bottom flange is configured to secure the hobby servo motor and the hobby servo mount to an operational environment. The side panel extends between and connects the top panel and the bottom flange. The top and bottom panels may be approximately parallel to each other, and the side panel may intersect the top and bottom panels perpendicularly or at an angle.

### REFERENCE TO RELATED CASE

The present application claims the priority of provisional application Ser. No. 61/550,629 filed on Oct. 24, 2011, the content of which is hereby incorporated by reference in its entirety.

### BACKGROUND

A servo motor (a.k.a. simply a “servo”) is a device having a rotatable output shaft. The output shaft can typically be positioned to specific angular positions in accordance with a coded signal received by the servo. It is common that a particular angular position will be maintained as long as a corresponding coded signal exists on an input line. If the coded signal changes, the angular position of the shaft will change accordingly. Control circuits and a potentiometer are typically included within the servo motor casing and are functionally connected to the output shaft. Through the potentiometer (e.g., a variable resistor), the control circuitry is able to monitor the angle of the output shaft. If the shaft is at the correct angle, the motor actuates no further changes. If the shaft is not at the correct angle, the motor is actuated in an appropriate direction until the angle is correct.

There are different types of servos that include output shafts having varying rotational and torque capabilities. For example, the rotational and/or torque capability of an industrial servo is typically less restricted than that of a hobby servo. That being said, hobby servos are generally available commercially at a cost that is much less than that associated with industrial servos.

Because hobby servos are relatively small and inexpensive, they are popular within the hobby-mechanical industry for applications such as, but by no means limited to, hobby robotic applications and radio-controlled models (cars, planes, boats, etc.). One example of a hobby servo is the Futaba S-148 available from Futaba Corporation of America located in Schaumburg, Ill.

### SUMMARY

An aspect of the disclosure relates to vertical hobby servo mounts. In certain circumstances, a servo mount includes a top panel, a bottom panel, and a side panel. The top panel is configured to secure a hobby servo motor to the hobby servo mount. The bottom flange is configured to secure the hobby servo motor and the hobby servo mount to an operational environment. The side panel extends between and connects the top panel and the bottom flange. The top and bottom panels may be approximately parallel to each other, and the side panel may intersect the top and bottom panels perpendicularly or at an angle. These and other features are discussed below and shown in the accompanying figures.

### BRIEF DESCRIPTION OF THE DRAWINGS

FIG. 1 is a perspective view of a hobby servo motor.

FIG. 2 is a perspective view of a pair of hobby servo mounts.

FIG. 3 is a perspective view of a pair of mounts attached to a hobby servo motor.

FIG. 4 is a side view of a hobby servo motor with attached mounts.

FIG. 5 is a top down view of a hobby servo motor with attached mounts.

FIG. 6-1 is a front view of a hobby servo mount.

FIG. 6-2 is a side view of a hobby servo mount.

FIG. 7. is a front view of a hobby servo mount showing some configuration options.

### DETAILED DESCRIPTION

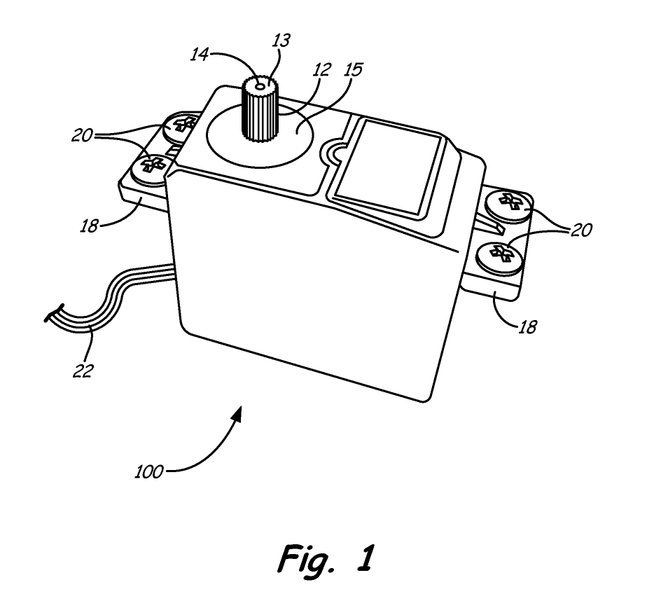

Certain embodiments described herein are intended for implementation in association with a motor such as, but not limited to, a hobby servo motor, or more simply stated, a hobby servo. FIG. 1 is a perspective view of one example of a suitable hobby servo 100. Hobby servo 100 can be any type of hobby servo and is not limited in terms of its style, capacity, motor speed, or load carrying capability. Hobby servo 100 is not intended to suggest any limitation as to the scope of use or functionality of the claimed subject matter. Neither should hobby servo 100 be interpreted as having any dependency or requirement relating to any one or combination of illustrated components.

Hobby servo 100 includes a rotatable splined output shaft 12, rotable splined shaft output top 13, threaded orifice 14, circular planar surface 15, a pair of flanges 18, mounting screws 20, and an electrical cable 22. Splined output shaft 12 has teeth (or ridges) distributed around the outside surface of the output shaft. This configuration is described as a “male” spline configuration. Standard configurations of hobby servos have 23, 24, or 25 teeth. Threaded orifice 14 extends into splined output shaft 12 and is adapted to receive an attachment screw (not shown). Flanges 18 are adapted to receive mounting screws 20. Flanges 18 and screws 20 are adapted to work in combination to mount hobby servo 100 in an operating environment. Electrical cable 22 is attached to the hobby servo 100 and provides electrical power and/or electrical signals to cause the output shaft 12 to rotate in a counter-clockwise or clockwise direction.

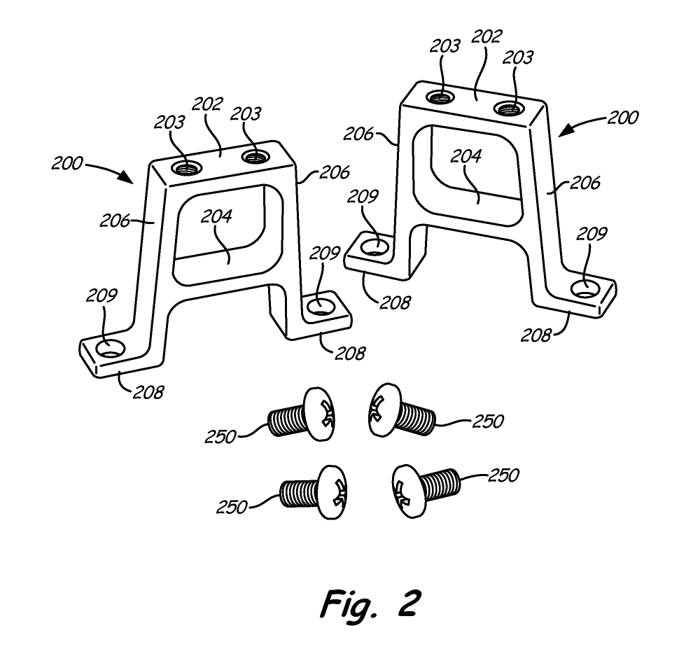

FIG. 2 is a perspective view of a pair of hobby servo mounts 200. Mounts 200 can be used to secure a hobby servo motor within an operating environment. Each mount 200 includes a top panel 202, a middle panel 204, two side panels 206, and two bottom flanges 208. Each top panel 202 illustratively includes one or more apertures 203, and each bottom flange 208 illustratively includes one or more apertures 209. In an embodiment, top panel apertures 203 are spaced apart and sized (i.e. diameter is sized) such that screws 250 can be utilized to attach the mounts 200 to a hobby servo motor. For example, screws 250 can fit through top panel apertures 203 and apertures in motor flanges 18 in FIG. 1. Additionally, bottom panel apertures 209 can be utilized to mount a hobby servo motor and attached mounts 200 within an operational environment. Accordingly, mounts 200 enable a hobby servo motor to be mounted within an operational environment in a different manner than the hobby servo motor could typically be mounted in. Therefore, mounts 200 provide flexibility and different options for mounting/securing a hobby servo motor within an operational environment.

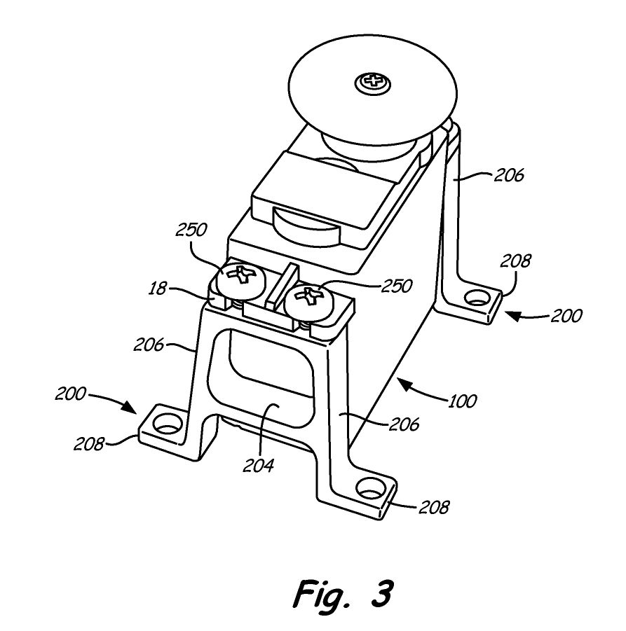

FIG. 3 shows a perspective view of mounts 200 attached to a hobby servo motor 100 utilizing screws 250. Several noteworthy features can be seen in the figure. First, it should be noted that side panels 260 are illustratively spaced apart from each other such that they do not extend past the hobby servo motor. In other words, side panels 260 are spaced apart such that they do not increase the footprint (i.e. the amount of space needed) to mount a hobby servo motor. In another embodiment, panels 260 can be spaced further apart or less far apart. Bottom flanges 208 illustratively extend outward from the side panels 206 such that they extend beyond the footprint of the hobby servo motor. In other embodiments, the bottom flanges 208 can be placed in different orientations as needed to mount a hobby servo motor within an operational environment. Finally with respect to FIG. 3, it can be seen that middle panels 204 illustratively act as a cross brace that provides additionally stability/durability for mounting a hobby servo motor. In other embodiments, a mount 200 optionally does not include a middle panel 204.

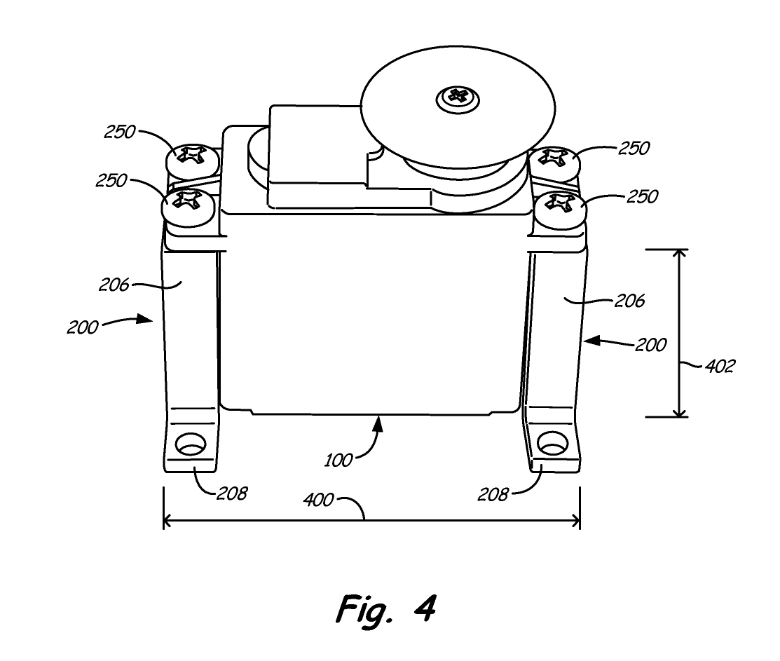

FIG. 4 is a side view of hobby servo motor 100 with mounts 200 attached utilizing screws 250. It should be noted that screws 250 are optional, and that other arrangements/configurations can be used to attach mounts 200 to motor 100 (e.g. fasteners, latches, interlocking components, etc.). Again, it can be seen that bottom flanges 208 extend outward from the body of motor 100 while side panels 206 optionally lie within the same plane as the side of the hobby servo motor 100. Additionally, it can be seen that an outer surface of side panels 206 is illustratively within the same plane as the flanges 18 of the motor such that an overall length 400 of the combined unit is not increased or is barely increased by the addition of the mounts. Similarly, the overall height 402 of the combined unit is not increased or is barely increased by the addition of the mounts.

FIG. 4 also shows that when supports 200 are attached to motor 100, that the supports may be approximately parallel to each other. In other embodiments, the supports 200 may be angled towards each other, or away from each other when attached to the hobby servo motor 100.

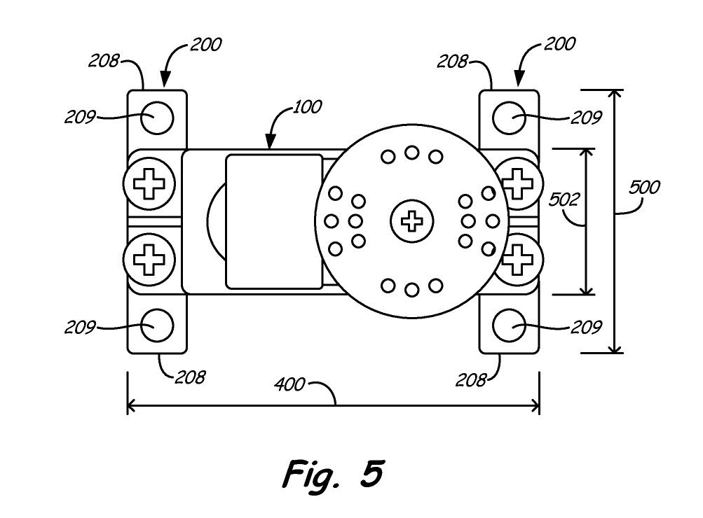

FIG. 5 is a top down view of hobby servo motor 100 with mounts 200 attached utilizing screws 250. As previously mentioned, mounts 200 illustratively are sized such that the overall length 400 of the servo motor 100 is not increased or is barely increased. In one embodiment, an overall width 500 of the mounts 200 is larger than the overall width 502 of the motor 100. This can be useful in providing additional mounting options, for increasing ability to access the mounting flanges, and for increasing stability of the unit. In another embodiment however, flanges 208 can be sized such that the overall width 500 is the same or approximately the same as width 502 of motor 100. Also, in FIG. 5, it can be seen that apertures 209 are circular or are approximately circular. It can further be seen that the diameters for each of the apertures are the same or approximately the same. In other embodiments, apertures 209 can be sized differently from one another, and can have shapes other than circular (e.g. square, oval, rectangular, etc.).

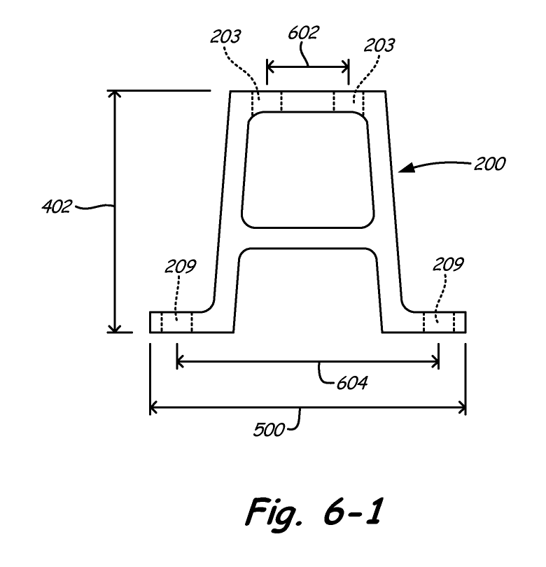

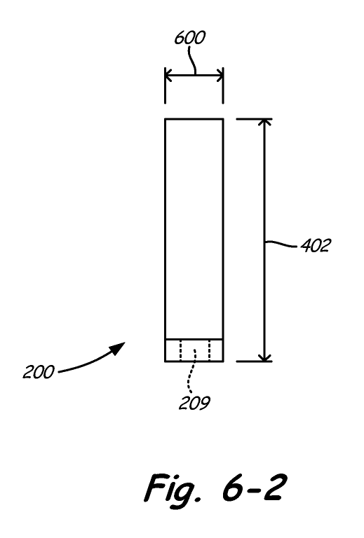

FIG. 6-1 shows a view of mount 200 from the front, and FIG. 6-2 shows a view of mount 300 from the side. Mount 200 illustratively has a depth 600. In one embodiment, depth 600 is approximately 0.275 inches. Embodiments are not however limited to any particular dimensions of depth 600 or of any other feature, and illustratively include all dimensions/sizes of any of the parts. Similarly, a height 402 of mount 200 is approximately 1.15 inches, a top panel aperture 203 spacing (center of hole to center hole) 602 is approximately 0.390 inches, a bottom flange aperture 209 spacing (center of hole to center of hole) 604 is approximately 1.25 inches, and a overall width is approximately 1.50 inches. Furthermore, apertures 203 are illustratively 6-32 tapped holes, and apertures 209 are 0.140 inch diameter holes. Again, these dimensions are illustrative only and embodiments are not limited to any particular dimensions, and embodiments illustratively include any dimensions.

In one embodiment, mounts 200 are made of a metal, such as but not limited to aluminum. Embodiments are not however limited to any particular material and mounts 200 can be made of other materials such as a synthetic material (e.g. plastic), etc. Furthermore, in one embodiment, mounts 200 include four 6-32×¼″ Pan Head Phillips Screws, and are designed for standard size Hitec and Futaba servos.

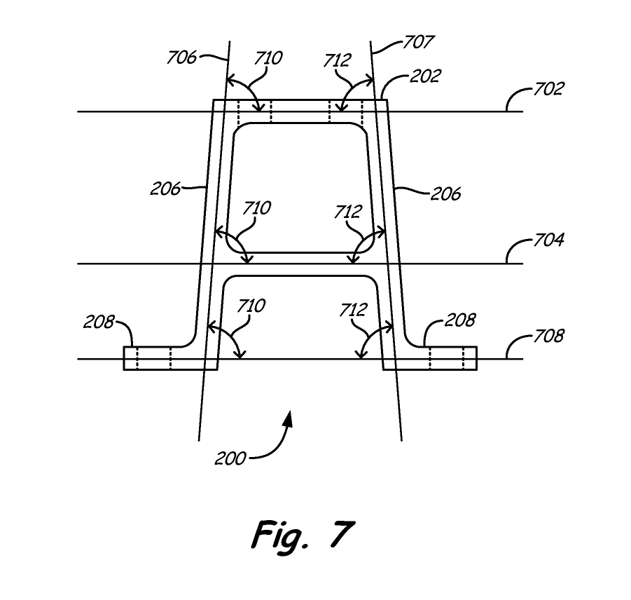

FIG. 7 is another side view of mount 200. FIG. 7 includes several imaginary lines or planes that are useful for showing some illustrative configurations of mount 200. In an embodiment, top panel 202 lies within, or at least approximately lies within an imaginary plane 702. Middle panel 204 lies within, or at least approximately lies within an imaginary plane 704. Bottom flanges 208 lie within, or at least approximately lie within an imaginary plane 708. First side panel 206 lies within, or at least approximately lies within an imaginary plane 706, and second side panel 206 lines within, or at least approximately lies within an imaginary plane 707. In one configuration, imaginary planes 702, 704, and 708 are parallel, or at least approximately parallel. Accordingly, the corresponding panels 202, 204, and 208 are similarly parallel or approximately parallel.

Imaginary planes 702, 704, and 708 illustratively intersect imaginary plane 706 at an angle 710. Similarly, planes 702, 704, and 708 illustratively intersect imaginary plane 707 at an angle 712. In an embodiment, both angles 710 and 712 are less than ninety degrees. Therefore, side panels 206 may be angled towards each other. In another embodiment, angles 710 and 712 can be ninety degrees or greater. Therefore, the side panels 206 may be approximately parallel to each other (i.e. 90 degrees), or the side panels 206 may be angled away from each other (i.e. angles greater than 90 degrees).

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. In addition, although the embodiments described herein are directed to vertical hobby servo mounts, it will be appreciated by those skilled in the art that the teachings of the disclosure can be applied to other types of components, without departing from the scope and spirit of the disclosure.

What is claimed is:

1. A hobby servo mount comprising:
a top panel that is configured to secure a hobby servo motor to the hobby servo mount;
a bottom flange that is configured to secure the hobby servo motor and the hobby servo mount to an operational environment; and
a side panel that extends between and connects the top panel and the bottom flange.

2. The hobby servo mount of claim 1, and further comprising:
a second side panel that extends between and connects the top panel and the bottom flange.

3. The hobby servo mount of claim 2, wherein the side panel and the second side panel are angled towards each other.

4. The hobby servo mount of claim 2, wherein the side panel and the second side panel are parallel to each other.

5. The hobby servo mount of claim 2, wherein the side panel and the second side panel are angled away from each other.

6. The hobby servo mount of claim 1, wherein the top panel and the bottom flange are at least approximately parallel to each other.

7. A hobby servo mount comprising:
a top panel that is configured to support a hobby servo motor;
a middle panel that is at least approximately parallel to the top panel; and
multiple bottom flanges that are at least approximately parallel to the top and middle panels, and that are configured to support the hobby servo motor in an operational environment.

8. The hobby servo mount of claim 7, and further comprising:
multiple side panels that connect the top panel, the middle panel, and the multiple bottom flanges.

9. The hobby servo mount of claim 7, wherein the multiple bottom flanges include one or more apertures for securing the hobby servo motor in the operational environment.

10. The hobby servo mount of claim 7, wherein the middle panel is located between the top panel and the multiple bottom flanges.

11. A hobby servo kit comprising:
a first hobby servo mount having a top portion and a bottom portion; and
a second hobby servo mount having a top portion and a bottom portion, the top portions being configured to secure a hobby servo motor, and the bottom portions being configured to secure the hobby servo motor to an operational environment.

12. The hobby servo kit of claim 11, and further comprising:
a hobby servo motor.

13. The hobby servo kit of claim 12, wherein the first and the second hobby servo mounts are approximately parallel when they are attached to the hobby servo motor.

14. The hobby servo kit of claim 12, wherein the first and the second hobby servo mounts are angled towards each other when they are attached to the hobby servo motor.

15. The hobby servo kit of claim 12, wherein the first and the second hobby servo mounts are angled away from each other when they are attached to the hobby servo motor.

16. The hobby servo kit of claim 12, wherein an angle of a rotational shaft of the hobby servo motor is controlled by a coded input signal.

17. The hobby servo kit of claim 16, wherein the angle of the rotational shaft is further controlled by an output from an external potentiometer.

18. The hobby servo kit of claim 16, wherein the angle of the rotational shaft is further controlled by an output from an internal potentiometer.

19. The hobby servo kit of claim 11, wherein a width of the bottom portions is greater than a width of the top portions.

20. The hobby servo kit of claim 11, wherein an overall length of the kit is at least approximately and an overall length of a hobby servo motor are at least approximately the same.
